(19) United States
(12) Patent Application Publication
(10) Pub. No.: US 2025/0342205 A1
(43) Pub. Date: Nov. 6, 2025

(54) SYSTEM(S) AND METHOD(S) FOR UTILIZING GENERATIVE MODEL(S) TO GENERATE CONTENT RESPONSIVE TO VIDEO DATA

(71) Applicant: GOOGLE LLC, Mountain View, CA (US)

(72) Inventors: Ágoston Weisz, Zurich (CH); Michael Andrew Goodman, Oakland, CA (US)

(21) Appl. No.: 18/656,309

(22) Filed: May 6, 2024

(51) Int. Cl. G06F 16/783; G06F 16/787; G10L 15/22

(52) U.S. Cl. CPC G06F 16/7837; G06F 16/787; G10L 15/22; G06F 16/785; G10L 2015/223

(57) ABSTRACT

Some implementations relate to receiving a stream of vision data and a representation of a spoken utterance; processing, using a generative model (GM), first GM input to generate corresponding first GM output, the first GM input including at least the stream of vision data and the representation of the spoken utterance; determining, based on the corresponding first GM output, a subset of the stream of vision data; processing, using the GM, second GM input to generate corresponding second GM output, the second GM input including at least the subset of the stream of vision data and the representation of the spoken utterance; determining, based on the corresponding second GM output, responsive content, wherein the responsive content is responsive to the spoken utterance and the stream of vision data; and causing the responsive content to be rendered at the client device.

### BACKGROUND

Various generative model(s) (GM(s)) have been proposed that can be used to process user input(s), to generate output that reflects generative content that is responsive to the user input(s). For example, large language models (LLM(s)) have been developed that can be used to process user input(s), to generate LLM output that reflects text-based generative content that is responsive to the user input(s). Further, GMs have been extended to model other modalities including visual inputs such as image data and video data. For instance, visual language models (VLMs) (also known as vision-language models or multi-modal language models), augment the natural language understanding power of LLMs with visual input understanding. A VLM can process a multi-modal input including a natural language (NL) input and a visual input and can, for example, perform reasoning regarding what is depicted in the visual input for a variety of NL and visual based tasks.

However, such visual inputs can include vast amounts of information, and only some of which may be relevant for a given visual based task. As such, processing visual inputs for execution of a visual based task can waste computational resources (e.g., because the visual inputs might include extraneous data which is not relevant for the execution of the visual based task), and given that GM(s) are typically executed at remote server(s) (e.g., due to their size), network resources can be wasted in transmitting the visual inputs to the remote server(s) since the extraneous data would also be transmitted. Furthermore, performance of visual based tasks can be variable, since any extraneous data included in the visual inputs can dilute information germane to the visual based task at hand included in the visual inputs and/or introduce irrelevant or contradictory information when the visual inputs are processed using GM(s) during execution of the visual based task at hand.

### SUMMARY

Some implementations described herein relate to utilizing GM(s) to generate content responsive to video content. According to the techniques described herein, the responsive content can be generated in an efficient manner (e.g., with respect to computational and network resources), and can be highly relevant to a particular visual based task. Processor(s) of a system can: determine a subset of a stream of vision data generated by vision component(s) of a client device; process, using a GM, GM input including the subset of video data and a representation of a spoken utterance to generate corresponding GM output; and determine responsive content responsive to the stream of vision data and the spoken utterance based on the GM output.

Vision data (e.g., an image frame or consecutive image frames (e.g., video frames)) can include vast amounts of information, which would be difficult or impossible to be included in natural language written by a user. As such, many GM tasks can be augmented or enabled by utilizing vision data. Furthermore, many client devices used for initiating execution of GM tasks can include vision components capable of generating vision data. For instance, almost all smartphones in use have access to one or more cameras. In some instances, client devices can continuously capture a stream of vision data. For instance, wearable devices can have access to one or more cameras which are configured to continuously capture a stream of vision data while active (e.g., using a ring buffer).

As such, many GM tasks can be augmented or enabled by utilizing vision data captured using a client device. However, in many instances, vision data captured using a client device can include extraneous data which is not relevant or otherwise not necessary for execution of a given visual based task. For instance, the vision data can include extraneous frames before and after frames which capture a subject relevant to the task (e.g., frames captured when a user of the client device is lifting the client device before and lowering the client device after capturing the relevant subject). As another example, the vision data can include pixels which do not relate to a subject relevant to the task, (e.g., pixels relating to a background of a scene). Processing vision data captured using a client device, including such extraneous data, can therefore waste computational resources (e.g., since the extraneous data is also processed). Furthermore, given that GM(s) are typically executed at remote server(s) (e.g., due to their size), network resources can be wasted in transmitting vision data captured using a client device to the remote server(s) (e.g., because the extraneous data is also transmitted). In addition, processing the extraneous data when performing a GM task can negatively impact the performance of the GM task.

Implementations described herein relate to filtering vision data captured using a client device, to determine a subset of the vision data captured using the client device. Content responsive to the vision data captured using the client device (e.g., and a spoken utterance corresponding to the vision data) can then be determined, utilizing one or more GMs.

In some implementations, the vision data captured using the client device can be filtered based on audio data captured using the client device corresponding to the vision data. For instance, a user of the client device can provide a spoken utterance whilst operating the client device to capture the vision data. The spoken utterance can relate to a particular GM task. It may therefore be determined that only frames (otherwise referred to as vision frames, image frames, video frames, etc.) captured whilst the spoken utterance is provided are relevant to the GM task. The subset of vision data to be further processed in furtherance of completion of the GM task can therefore include frames captured whilst the spoken utterance is provided. For instance, frames captured before and after the spoken utterance is provided (and optionally other frames or subsets of other frames) can be excluded from the subset of vision data.

In some implementations, the vision data captured using the client device can be filtered based on an initial “understanding” procedure utilizing one or more GM(s). For instance, following the example above, audio data captured using the client device corresponding to the vision data can include a spoken utterance provided by a user. The subset of video data can then be determined based on processing, using the GM(s), the vision data as well as a representation of the spoken utterance (e.g., the audio data capturing the spoken utterance, a transcript of the spoken utterance, and/or a natural language understanding (NLU) representation of the spoken utterance). For instance, the subset of the vision data can include frames of the vision data determined to be relevant to the task. Additionally, or alternatively, the subset of the vision data can include cropped and/or masked frames of the vision data (e.g., based on one or more objects present in the frames determined to be relevant to the task). In some implementations, the subset of the vision data can include latent data usable by one or more GMs to generate responsive content.

Once the subset of the vision data has been determined, responsive content responsive to the vision data and the spoken utterance can be determined, based on processing the subset of the vision data and the spoken utterance using one or more GMs in a “response generation” procedure. The responsive content can then be rendered at the client device to the user.

As a non-limiting example, assume the stream of vision data captures an environment of the client device, where the environment includes one or more objects also captured in the stream of vision data. The responsive content can therefore be responsive to an object of the environment captured in the stream of vision data. In some implementations, the user can explicitly indicate the object of interest (e.g., in the stream of vision data and/or the spoken utterance). For instance, the stream of vision data can include one or more frames capturing a user gesture indicative of a particular object (e.g. a hand of the user pointing towards the particular object). Additionally, or alternatively, the spoken utterance can identify the object of interest in the environment captured by the vision data. For instance, the spoken utterance can identify the object of interest based on one or more properties of the object. The one or more properties of the object can include, for instance, an object type of the object (e.g., “what is the model of that car?”), a color of the object (e.g., “how do I get to the blue building over there?”), a location of the object in the environment (e.g., “who wrote that book on the left?”, “what is the name of the volcano in the background”), etc. In some implementations, the object of interest can be inferred (e.g., based on the stream of vision data and/or the spoken utterance). For instance, the spoken utterance can include a request to identify an object, from among a plurality of objects present in the environment captured by the vision data (e.g., “what is that?”). The object of interest can then be inferred based on a prominence in the vision data (e.g., it can be inferred that the most prominent object in the stream of vision data is the object of interest). For instance, a prominence of a given object can be determined based on one or more of: a size of the object in the stream of vision data (e.g., larger objects can be considered more prominent), a number and/or percentage of frames of the stream of vision data which capture the object (e.g., an object which appears more often in the stream of vision data can be considered more prominent), a determined distance between the client device and the object (e.g., closer objects can be considered more prominent), a location of the object in the vision data (e.g., an object more central in the vision data can be considered more prominent), etc. As such, the responsive content can be responsive to the object of interest (e.g., by including content identifying the object, providing information about or relating to the object, providing directions to the object, etc.). Furthermore, the initial vision data can be filtered such that the subset of vision data is focused on the object of interest (e.g., by including one or more frames where the object is present, by cropping or masking frames to remove information unrelated to the object, etc.). In this way the responsive content can be expected to be more relevant to the object of interest, and can be generated with lower computational and network resource consumption (e.g., because the vision data not included in the subset of vision data is not processed and/or transmitted when generating the responsive content).

In some implementations, user input can be received subsequent to the responsive content. For instance, the subsequent user input can include a spoken utterance, NL text entered by the user, selection of a graphical user interface element, etc. The subsequent user input can be indicative of a request for additional responsive content. For instance, the initial responsive content can be responsive to a particular object present in the vision data, and the subsequent user input can be indicative of a request for additional responsive content responsive to another object present in the vision data (e.g., “no, the car on the left”), or at least additional responsive content which is not responsive to the particular object (e.g., “not that car”). As a result, additional responsive content can be generated in a similar manner to the initial responsive content (with or without generating a new subset of vision data based on the subsequent user input), and can be generated such that it is biased towards the other object and/or away from the particular object accordingly (e.g., by additionally processing the subsequent user input or a representation thereof when generating the subset of the vision data and/or the responsive content). The additional responsive content can then be rendered to the user. In some implementations, further subsequent user input can be received subsequent to the additional responsive content being rendered, and this process can repeat accordingly.

In some implementations, the same GM(s) can be used for both the understanding procedure and the response generation procedure. For instance, a single multi-modal GM can be used in determining both the subset of the vision data and the responsive content based on the subset of vision data. In some other implementations, different GM(s) can be used for the understanding procedure and the response generation procedure. For instance, a single multi-modal GM can be used in determining the responsive content, and a reduced version (e.g., with less weights, lower token limit, etc.) of that GM can be used in determining the subset of vision data. In some implementations, multi-modal GM(s) can be used, which can process both the representation of the spoken utterance and the vision data based on a single call. In some implementations, multiple GMs having respective modalities which can process the representation of the spoken utterance and the vision data respectively using respective calls to the multiple GMs can be used, where each of the multiple GMs can be jointly fine-tuned in an end-to-end manner.

By implementing techniques described herein, one or more technical advantages can be achieved. As one non-limiting example, by initially filtering the vision data to be processed in generating the responsive content responsive to the vision data, computational resources which would otherwise be consumed without such filtering can be conserved. This is particularly the case in implementations involving filtering (e.g., by end-pointing the vision data based on the beginning and the end of the spoken utterance) prior to the understanding procedure described herein, as well as implementations involving a reduced GM for the understanding procedure described herein.

Furthermore, in implementations including the client device initially filtering the vision data prior to transmitting the vision data for processing at a remote server(s), network resources which would otherwise be consumed without such filtering can be conserved.

Furthermore, by filtering extraneous information in the vision data prior to generation of the responsive content, germane information in the vision data can be less diluted when generating the responsive content, and processing of irrelevant and/or contradictory information included in the vision data can be avoided or at least reduced. As such, performance of visual based tasks can be improved. As an example, implementations described herein can result in user queries based on objects present in vision data (e.g., “What is that green thing?”) to be satisfied correctly more often and/or more accurately.

Furthermore, some implementations described herein can allow personal or sensitive data to be removed from vision data and/or a representation of the spoken utterance transmitted by the client device. For instance, faces detected in the vision data can be masked or blurred on device during the initial filtering stage prior to transmission. Additionally, or alternatively, latent data (e.g., embeddings) based on the vision data and/or spoken utterances generated on device during the initial filtering stage can be sent in lieu of the vision data or spoken utterance representations.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a process flow for utilizing various components from the example environment of FIG. 1, in accordance with various implementations.

FIG. 3A and FIG. 3B depict flowcharts illustrating example methods of utilizing generative model(s) (GM(s)) to generate content responsive to vision data, in accordance with various implementations.

FIG. 4 depicts a flowchart illustrating an example method of generating additional responsive content based on a subsequent user input, in accordance with various implementations.

FIG. 5A and FIG. 5B depict various non-limiting examples of generating content responsive to vision data, in accordance with various implementations.

FIG. 6 depicts an example architecture of a computing device, in accordance with various implementations.

### DETAILED DESCRIPTION OF THE DRAWINGS

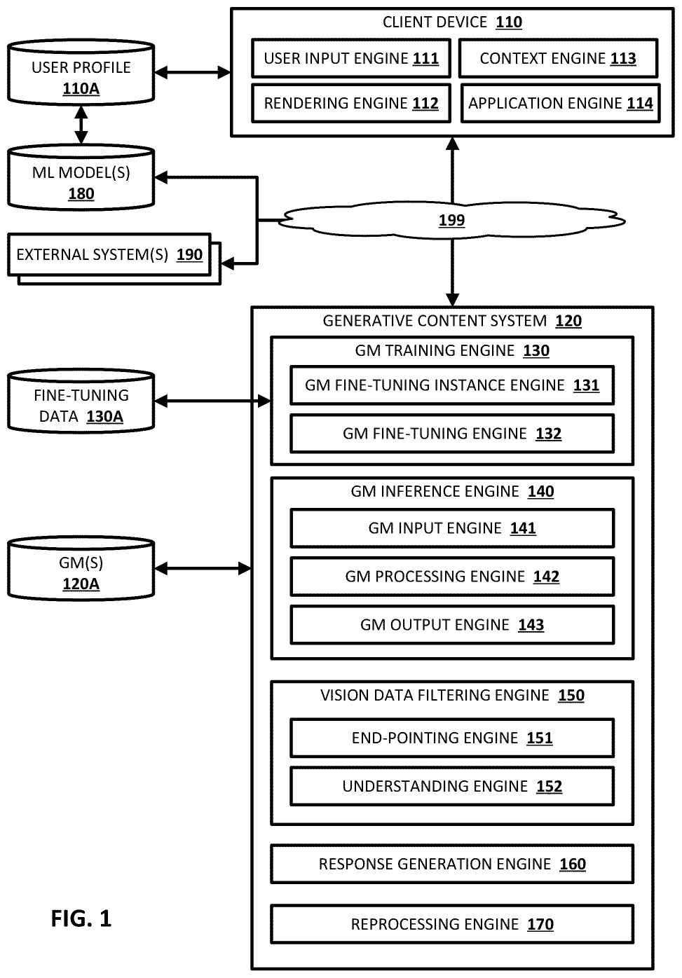

Turning now to FIG. 1, a block diagram of an example environment that demonstrates various aspects of the present disclosure, and in which implementations disclosed herein can be implemented is depicted. The example environment includes a client device 110 and a generative content system 120. In some implementations, all or aspects of the generative content system 120 can be implemented locally at the client device 110. In additional or alternative implementations, all or aspects of the generative content system 120 can be implemented remotely from the client device 110 as depicted in FIG. 1 (e.g., at remote server(s)). In those implementations, the client device 110 and the generative content system 120 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 114, through which touch inputs and/or other user inputs can be submitted and/or content that is responsive to the touch inputs and/or the other user inputs can be rendered (e.g., audibly and/or visually). The application engine 114 can execute one or more software applications that are separate from an operating system of the client device 110 (e.g., one installed “on top” of the operating system)—or can alternatively be implemented directly by the operating system of the client device 110. For example, the application engine 114 can execute a web browser, vision-based search engine, or automated assistant installed on top of the operating system of the client device 110. As another example, the application engine 114 can execute a web browser software application, a vision-based search engine software application, or automated assistant software application that is integrated as part of the operating system of the client device 110. The application engine 114 (and the one or more software applications executed by the application engine 114) can interact with or otherwise provide access to (e.g., as a front-end) the generative content system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110.

In some versions of those implementations, the client device 110 can utilize one or more machine learning (ML) model(s) stored in ML model(s) database 180 to process the user input. For example, the user input received at the client device 110 may be a spoken utterance. In these examples, the user input engine 111 can process, using automatic speech recognition (ASR) model(s) stored in the ML model(s) database 180 (e.g., a recurrent neural network (RNN) model, a transformer model, and/or any other type of ML model capable of performing ASR), audio data that capture the spoken utterance and that is generated by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 111 can select one or more of the speech hypotheses as recognized text that corresponds to the spoken utterance (e.g., based on the corresponding predicted values for each of the speech hypotheses), such as when the user input engine 111 utilizes an end-to-end ASR model. In other implementations, the user input engine 111 can select one or more of the predicted phonemes (e.g., based on the corresponding predicted values for each of the predicted phonemes), and determine recognized text that corresponds to the spoken utterance based on the one or more predicted phonemes that are selected, such as when the user input engine 111 utilizes an ASR model that is not end-to-end. In these implementations, the user input engine 111 can optionally employ additional mechanisms (e.g., a directed acyclic graph) to determine the recognized text that corresponds to the spoken utterance based on the one or more predicted phonemes that are selected.

In various implementations, the client device 110 can include a rendering engine 112 that is configured to render content for audible and/or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as textual content, and optionally along with other visual content (e.g., image(s), video(s), etc.), via the client device 110.

In some versions of those implementations, the client device 110 can utilize one or more of the ML model(s) stored in the ML model(s) database 180 to process content described herein. For example, and as noted above, the content can be audibly rendered as audible content via the speaker(s) of the client device 110. In these examples, the rendering engine 112 can process, using text-to-speech (TTS) model(s) stored in the ML model(s) database 180, content (e.g., responsive content generated using the generative content system 120) to generate synthesized speech audio data that includes computer-generated synthesized speech capturing the responsive content. In implementations where the rendering engine 112 utilizes the TTS model(s) to process the content, the rendering engine 112 can generate the synthesized speech using a particular set of one or more prosodic properties (e.g., that define a tone, pitch rhythm, speed, etc. of the computer-generated synthesized speech) and/or using a particular voice embedding to reflect different personas and/or speaking styles, such as a particular set of one or more prosodic properties associated with the user of the client device 110 and/or a voice embedding associated with the user of the client device 110.

Notably, although the ML model(s) stored in the ML model(s) database 180 are described above as being implemented locally by the client device 110, it should be understood that is for the sake of example and is not meant to be limiting. For instance, the audio data that captures the spoken utterance can additionally, or alternatively, be streamed to the generative content system 120, and the generative content system 120 can utilize the ASR model(s) stored in the ML model(s) database 180 (or separate cloud-based ASR model(s)) to generate the ASR output. Also, for instance, the summary of the content can be additionally, or alternatively, be processed by the generative content system 120 utilizing the TTS model(s) stored in the ML models) database 180 (or separate cloud-based TTS model(s)) to generate the synthesized speech audio data, and the synthesized speech audio data can be streamed to the client device 110 (or an additional client device of the user) to cause the synthesized speech audio date to audibly rendered for presentation to the user of the client device 110.

In various implementations, the client device 110 can include a context engine 113 that is configured to determine a client device context (e.g., current or recent context) of the client device 110 and/or a user context of a user of the client device 110 (or an active user of the client device 110 when the client device 110 is associated with multiple users). In some of those implementations, the context engine 113 can determine a context based on data stored in user profile database 110A. The data stored in the user profile database 110A can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, and/or any other data accessible to the context engine 113 via the user profile database 110A or otherwise.

For example, the context engine 113 can determine a current context based on a current state of a dialog session (e.g., considering one or more recent user inputs provided by a user during the dialog session) and/or a current location of the client device 110. For instance, the context engine 113 can determine a current context of “visitor looking for upcoming events in Louisville, Kentucky” based on a recently issued query and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting user inputs that are received at the client device 110, in generating an implied user input (e.g., an implied query or prompt formulated independent of any explicit user input provided by a user of the client device 110), and/or in determining to submit an implied user input and/or to render result(s) (e.g., the content) for an implied user input.

Further, the client device 110 and/or the generative content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The generative content system 120 is illustrated in FIG. 1 as including a generative model (GM) training engine 130, a GM inference engine 140, a vision data filtering engine 150, a response generation engine 160, and a reprocessing engine 170. Some of these engines can be combined and/or omitted in various implementations. Further, these engines can include various sub-engines. For instance, the GM training engine 130 is illustrated in FIG. 1 as including a GM fine-tuning instance engine 131 and a GM fine-tuning engine 132. Further, the GM inference engine 140 is illustrated in FIG. 1 as including a GM input engine 141, a GM processing engine 142, and a GM output engine 143. Moreover, the vision data filtering engine 150 is illustrated in FIG. 1 as including an end-pointing engine 151, and an understanding engine 152. Similarly, some of these sub-engines can be combined and/or omitted in various implementations. Accordingly, it should be understood that the various engines and sub-engines of the generative content system 120 illustrated in FIG. 1 are not meant to be limiting.

Further, the generative content system 120 is illustrated in FIG. 1 as interfacing with various databases, such as GM(s) database 120A and fine-tuning data database 130A. Although particular engines and/or sub-engines are depicted as having access to particular databases, it should be understood that is for the sake of example and is not meant to be limiting. For instance, in some implementations, each of the various engines and/or sub-engines of the generative content system 120 may have access to each of the various databases. Further, some of these databases can be combined and/or omitted in various implementations. Accordingly, it should be understood that the various databases interfacing with the generative content system 120 illustrated in FIG. 1 are not meant to be limiting.

Moreover, the generative content system 120 is illustrated in FIG. 1 as interfacing with other system(s), such as external system(s) 190. The external system(s) can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.). In some implementations, the external system(s) 190 are first-party system(s), whereas in other implementations, the external system(s) 190 are third-party system(s). As used herein, the term “first-party” or “first-party entity” refers to an entity that controls, develops, and/or maintains the generative content system 120, whereas the term “third-party” or “third-party entity” refers to an entity that is distinct from the entity that controls, develops, and/or maintains the generative content system 120.

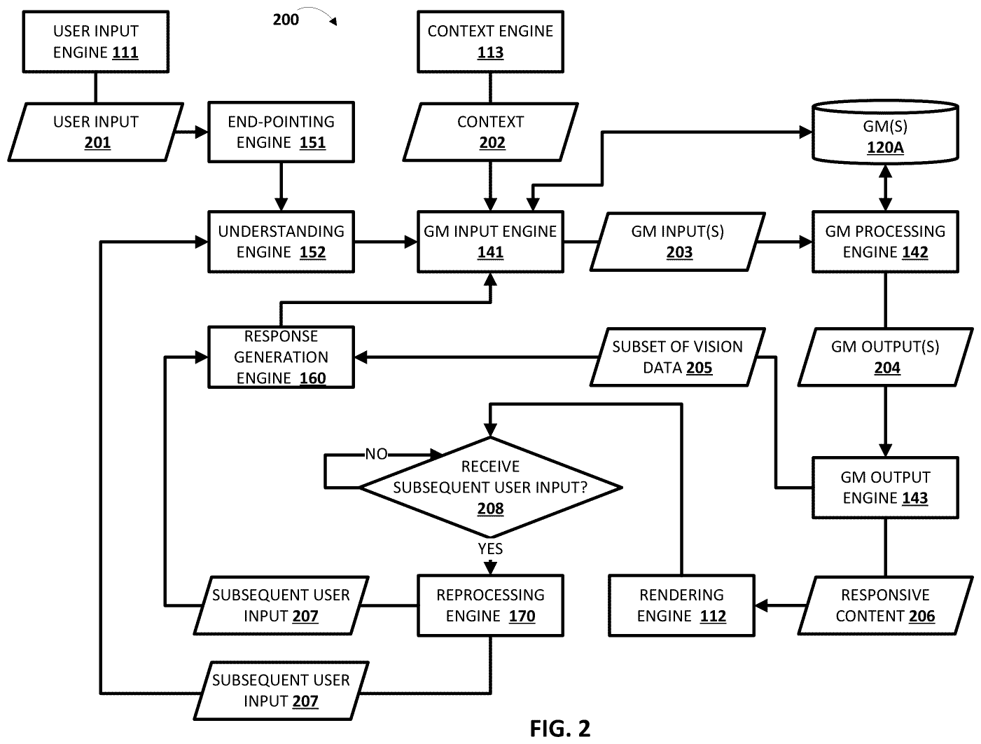

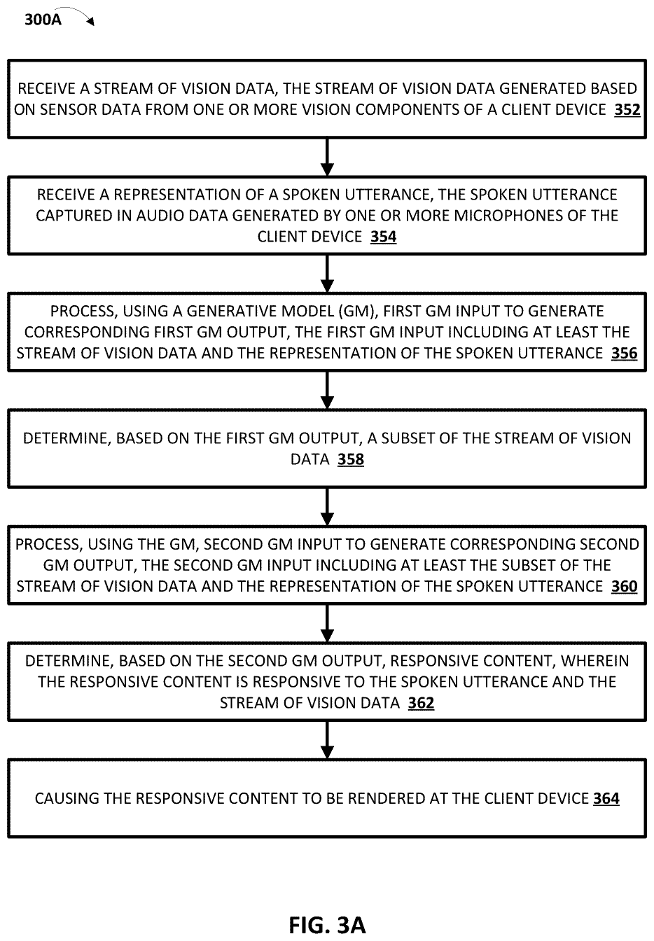

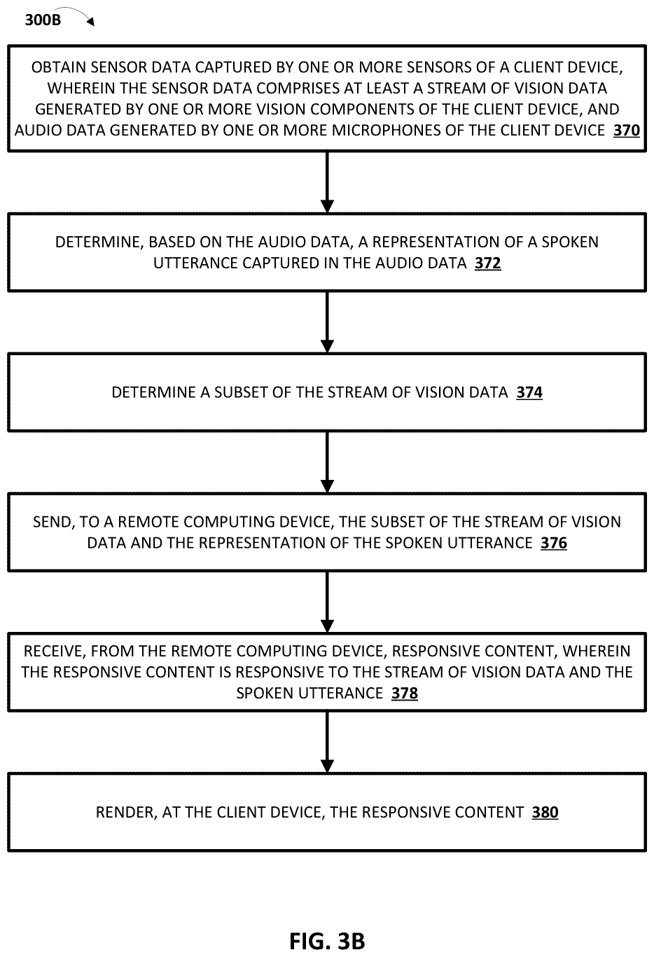

As described in more detail herein (e.g., with respect to FIGS. 2, 3A-3B, 4, and 5A-5B), the generative content system 120 can be utilized to generate responsive content to be rendered for presentation to a user of the client device 110 and in response to receiving user input that includes a stream of vision data and a representation of a spoken utterance. As also described in more detail herein, the responsive content can be generated based on determining a subset of the stream of vision data (e.g., in some implementations using an “understanding” procedure), and a “response generation” procedure, in which responsive content is determined based on the subset of the stream of vision data (e.g., as described with respect to FIG. 3A and FIG. 3B). The stream of vision data can include, for example, video data, which can include a plurality of sequential frames (otherwise referred to as image frames, video frames, etc.). The plurality of sequential frames can be captured by one or more vision components (e.g., camera(s)) of the client device 110. In some implementations, the plurality of sequential frames can be captured in response to a user input at the client device 110 (e.g., selection of a graphical user interface element rendered at the client device 110 or a physical button of the client device 110 to start capturing video data). In some implementations, the client device 110 can be configured to continuously capture video data, and the stream of vision data can include sequential frames taken from the continuously captured video data. For instance, as described herein, the stream of vision data can include sequential frames corresponding to a time period in which a spoken utterance was spoken (e.g., with a starting frame corresponding to a time when a spoken utterance was started and a final frame corresponding to a time when the spoken utterance has ended). In some implementations, the stream of vision data can additionally or alternatively include data other than video data. For instance, the stream of vision data can include NL text describing captured video data (e.g., such as VQA output). As another example, the stream of vision data and/or the subset of the stream of vision data can include latent data generated based on captured video data (e.g., embeddings determined based on one or more frames of the captured video data). The latent data can be usable by one or more GMs in determining responsive content. The subset of the stream of vision data can include at least some of the stream of vision data. For instance, when the stream of vision data includes video data, the subset of the stream of vision data can include one or more of the frames of the video data, frames of the video data which have been masked and/or cropped, etc.; when the stream of vision data includes NL text describing captured video data, the subset of the stream of vision data can include at least some (e.g., less than all) of the NL text describing the captured video data; when the stream of vision data includes latent data, the subset of the stream of vision data can include some (e.g., less than all) of the latent data. The representation of the spoken utterance can include, for example, audio data (e.g., audio data capturing the spoken utterance), NL text characterizing the spoken utterance (e.g., a transcription of the spoken utterance), and/or latent data characterizing the spoken utterance (e.g., NLU representations of the spoken utterance).

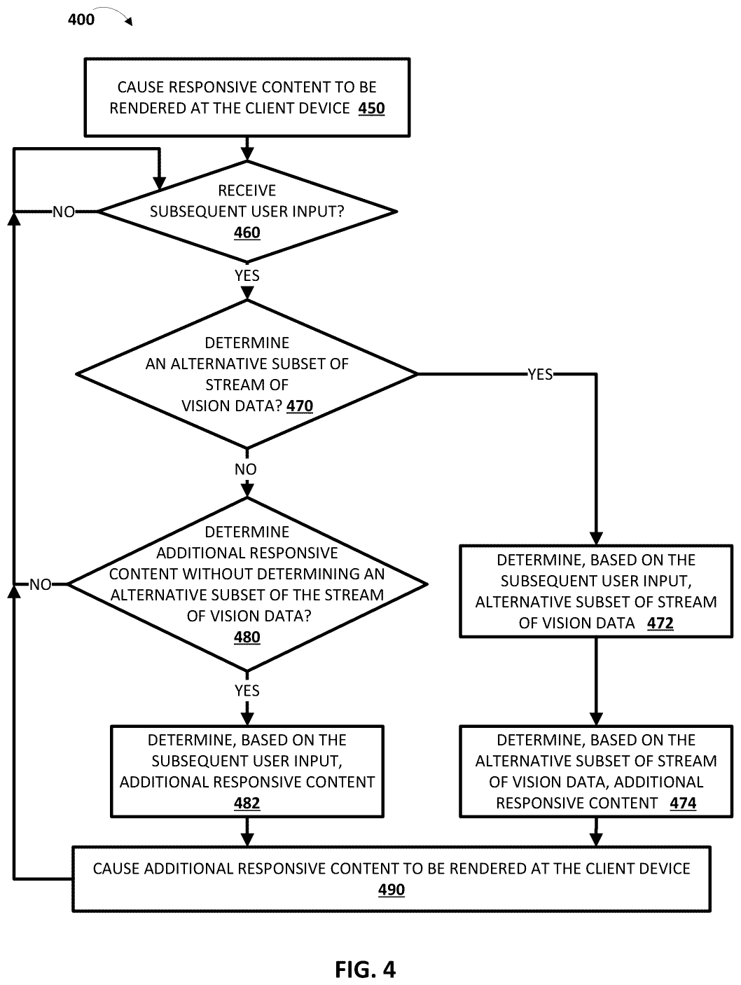

In some implementations, the subset of the stream of vision data and the responsive content can be generated using a single multi-modal GM. In these implementations, the GM can be fine-tuned to process both the vision data and the representation of the spoken utterance. In additional or alternative implementations, a first GM can be used in determining the subset of the stream of vision data, and a second GM can be used in determining the responsive content. In some of these implementations, the first GM is a reduced version of the second GM (e.g., relative to the second GM, the first GM has fewer weights or parameters, a lower token limit, etc.). In additional or alternative implementations, the subset of the stream of vision data and/or the responsive content can be generated using respective calls to multiple GMs. In these implementations, each of the multiple GMs can be jointly fine-tuned in an end-to-end manner to process respective portions of the user input (e.g., based on the respective modalities of the respective portions of the user input) and/or to generate respective portions of the responsive content. In various implementations, the generative content system 120 can be utilized to generate additional responsive content to be rendered for presentation to the user of the client device 110 and in response to receiving subsequent user input(s) (e.g., as described with respect to FIG. 4).

As indicated above, in implementations where the subset of the stream of vision data and/or the responsive content are generated using multi-modal GM(s), the multi-modal GM(s) can be fine-tuned to generate the subset of the stream of vision data and/or the responsive content accordingly. The multi-modal GM(s) can be stored in the GM model(s) database 120A, and can include any GM (e.g., Bard, Gemini, GPT, and/or any other GM, such as any other GM that is encoder-only based, decoder-only based, sequence-to-sequence based and that optionally includes an attention mechanism or other memory). Notably, the GM(s) stored in the GM(s) database 120A can include millions or billions of weights and/or parameters that are learned through initially training the GM on enormous amounts of diverse data. This enables these GM(s) to generate GM output as a probability distribution over a sequence of tokens as described herein. Further, in implementations utilizing multi-modal GM(s), the multi-modal GM(s) can be fine-tuned to be capable of processing text-based user inputs (e.g., typed user inputs or transcriptions of spoken utterances provided by the user of the client device 110), audio-based user inputs (e.g., audio data capturing spoken user inputs provided by the user of the client device 110), and/or vision-based user inputs (e.g., image(s) and/or video(s) provided by the user of the client device 110) to generate text-based content (e.g., text corresponding to vision data and/or to representations of spoken utterances, as described herein), audio-based content (e.g., audio data corresponding to vision data and/or to representations of spoken utterances, as described herein), and/or visual-based content (e.g., image(s) and/or video(s) corresponding to vision data and/or to representations of spoken utterances, as described herein).

In fine-tuning the multi-modal GM(s), the GM fine-tuning instance engine 131 can access the fine-tuning data database 130A to obtain a plurality of fine-tuning instances. For instance, in fine-tuning a multi-modal GM for determining a subset of vision data from initial vision data, each of the plurality of fine-tuning instances can include a corresponding fine-tuning user input (e.g., including vision data and a representation of a spoken utterance), and a corresponding fine-tuning subset of the vision data included in the corresponding fine-tuning user input. Further, in fine-tuning the multi-modal GM for determining a subset of vision data from initial vision data based on a given fine-tuning instance, of the plurality of fine-tuning instances, the GM fine-tuning engine 132 can process the corresponding user input to generate a predicted subset of the vision data. In some implementations, the GM fine-tuning engine 132 can compare the predicted subset of the vision data to the corresponding fine-tuning subset of the vision data for the given fine-tuning instance to generate one or more losses. Additionally, or alternatively, in fine-tuning the multi-modal GM for determining a subset of vision data from initial vision data, each of the plurality of fine-tuning instances can include a corresponding fine-tuning user input (e.g., including vision data and a representation of a spoken utterance), and corresponding fine-tuning responsive content. Further, in fine-tuning the multi-modal GM for determining a subset of vision data from initial vision data based on a given fine-tuning instance, of the plurality of fine-tuning instances, the GM fine-tuning engine 132 can process the corresponding user input to generate a predicted subset of the vision data, and can process the predicted subset of the vision data and at least the representation of the spoken utterance from the corresponding user input to generate predicted responsive content. In some implementations, the GM fine-tuning engine 132 can compare the predicted responsive content to the corresponding fine-tuning predicted responsive content for the given fine-tuning instance to generate one or more losses. Moreover, the GM fine-tuning engine 132 can update the multi-modal GM for determining a subset of vision data from initial vision data based on one or more of the losses.

Moreover, in fine-tuning a multi-modal GM for determining responsive content, each of the plurality of fine-tuning instances can include a corresponding fine-tuning user input (e.g., including vision data and a representation of a spoken utterance), and corresponding fine-tuning responsive content. Further, in fine-tuning the multi-modal GM for determining responsive content based on a given fine-tuning instance, of the plurality of fine-tuning instances, the GM fine-tuning engine 132 can process the corresponding user input to generate predicted responsive content. In some implementations, the GM fine-tuning engine 132 can compare the predicted responsive content to the corresponding fine-tuning responsive content for the given fine-tuning instance to generate one or more losses. Moreover, the GM fine-tuning engine 132 can update the multi-modal GM for determining responsive content based on one or more of the losses.

In some implementations, the multi-modal GM for determining responsive content is the same GM used for determining a subset of vision data. In some implementations, the multi-modal GM used for determining a subset of vision data is a reduced version of the multi-modal GM used for determining responsive content. Moreover, although fine-tuning for determining responsive content and fine-tuning for determining the subset of vision data have been generally been discussed independently herein, it will be appreciated that in some implementations, fine-tuning for these tasks can be connected (e.g., fine-tuning for determining the subset of vision data can be at least partly based on a comparison of fine-tuning responsive content, and predicted responsive content determined based on a predicted subset of vision data during fine-tuning for determining responsive content). Further, although multi-modal GM(s) have generally been discussed herein, it will be appreciated that in some implementations, GMs which are fine-tuned to process particular portions of the user input and/or to generate particular portions of the responsive content (e.g., according to the modality of the particular portions) can be used. These GMs can be fine-tuned in a similar manner to that described herein in relation to multi-modal GM(s). In some implementations, these GMs can be jointly fine-tuned in an end-to-end manner.

Although particular learning techniques for fine-tuning GM(s) are described above (e.g., supervised fine-tuning (SFT) techniques) it should be understood that is for the sake of example and is not meant to be limiting. For instance, the GM fine-tuning engine 132 can additionally, or alternatively, utilize a reinforcement learning from human feedback (RLHF) technique where the predicted subset of visual data and/or the predicted responsive content is provided for presentation to a developer associated with the generative content system 120 and the developer can provide feedback with respect to the predicted subset of visual data and/or the predicted responsive content given the corresponding fine-tuning user input that was processed using the GM(s). However, it should be noted that techniques that require involvement of the developer (or other users, such as Mechanical Turks) consume additional computational and pecuniary resources.

Turning now to FIG. 2, a process flow for utilizing various components from the example environment of FIG. 1 is depicted. For the sake of example, assume that the user of the client device 110 provides user input 201 and the user input 201 is detected via the user input engine 111. For instance, assume that the user input 201 includes vision data including a plurality of sequential frames capturing an environment with a plurality of objects, and a representation of the spoken utterance of “what does that sign mean”. In this example, the end-pointing engine 151 can process the user input 201 to initially filter the captured vision data. For instance, the end-pointing engine 151 can identify a first frame of the plurality of sequential frames based on determining which of the frames corresponds with a time that the spoken utterance was started. The end-pointing engine 151 can alternatively, or additionally, identify a final frame of the plurality of sequential frames based on determining which of the frames corresponds with a time that the spoken utterance ended. The end-pointing engine 151 can thus identify a subset of the plurality of sequential frames (e.g., by excluding frames captured before the first frame and/or after the final frame) for further processing.

In this example, the understanding engine 152 can process the user input 201 (e.g., which may have been processed (or in other words, end-pointed) by the end-pointing engine 151, as described herein) in order to determine a subset of the vision data 205. This can be referred to as the “understanding” procedure. The response generation engine 160 can process the subset of vision data 205 in order to determine responsive content 206 responsive to the user input 201. This can be referred to as the “response generation” procedure.

In this example, the GM input engine 141 can process the user input 201 (e.g., which may have been processed by the end-pointing engine 151, as described herein), and in some cases the subset of vision data 205, to generate GM input(s) 203. Notably, in generating the GM input(s) 203, the GM input engine 141 can utilize an explicitation GM (e.g., stored in the GM(s) database 120A). The explicitation GM can be one form of a GM that processes the user input 201 (and optionally context 202 determined by the context engine 113 of the client device 110) to generate the GM input(s) 203. The GM input(s) 203 can then be provided to the GM processing engine 142 to generate GM output(s) 204. Put another way, the GM input engine 141 can utilize the explicitation GM to process the raw user input 201 and put it in a structured form that is more suitable for processing by the GM processing engine 142. Further, the GM input engine 141 can utilize the explicitation GM to incorporate the context 202 into the GM input(s) 203 and optionally any other dynamic prompts to aid the GM processing engine 142 in generating the GM output(s) 204. For instance, based on the user input 201 including a representation of the spoken utterance of “what does that sign mean”, the context 202 can include an indication that the user's preferred language is English and that they are currently visiting Japan based on user profile data stored in the user profile database 110A, common types of signs in Japan (e.g., obtained via a call to one of the external system(s) 190, such as the Internet), and/or other context.

During the understanding procedure, instructions can be included in the GM input(s) to request that a subset of the vision data of the user input 201 be determined, for instance, by generating a dynamic prompt to do so. For instance, based on the user input including a representation of the spoken utterance “what does that sign mean”, and the relevant context information, a dynamic prompt can include, for instance, “Identify the most prominent sign present in the vision data, provide an indication of one or more frames in which this sign is clearly visible”, or the like. During the response generation procedure instructions can be included in the GM input(s) to request that content responsive to the user input 201 be generated, for instance, by generating a dynamic prompt to do so. For instance, based on the user input 201 including a representation of the spoken utterance “what does that sign mean”, and the relevant context information, a dynamic prompt can include, for instance, “Provide a meaning of the sign present in the vision data, translate any text present on the sign from Japanese to English” or the like. Additionally, or alternatively, the understanding procedure can utilize one or more GM(s) which are fine-tuned for determining a subset of vision data based on user input. As such, the GM input(s) need not include explicit instructions to determine a subset of vision data. Similarly, in some implementations, the response generation procedure can utilize one or more GM(s) which are fine-tuned for determining responsive content based on user input. As such, the GM input(s) need not include explicit instructions to determine responsive content.

The GM processing engine 142 can process, using one or more GM(s) from among the GM(s) database 120A, the GM input(s) 203 to generate the GM output(s) 204. Moreover, in these implementations, the GM output(s) 204 may include probability distributions over sequences of tokens. For example, in determining a subset of the vision data 205 of the user input 201 (which may or may not have been processed by end-pointing engine 151), the GM output engine 143 can employ various decoding techniques to determine the subset of vision data 205 from indications of the subset of vision data (e.g., relevant frames or pixels of the vision data of the user input 201, location(s) of mask(s) in one or more frames of the vision data of the user input 201, a cropping configuration for one or more frames of the vision data of the user input 201, one or more objects present in the vision data of the user input 201, etc.), and based on the probability over the sequence of tokens. Further, in determining responsive content 206, the GM output engine 143 can employ various decoding techniques to determine the responsive content 206 from a sequence of words or word units (e.g., text-based output) or from a sequence of phonemes or phonetic units (e.g., audio-based output) and based on the probability distribution over the sequence of words or word units or over the sequence of phonemes or phonetic units.

Further, the rendering engine 112 can cause the responsive content 206 to be rendered at the client device 110 of the user as the responsive content and responsive to the user input 201.

In various implementations, and as indicated at block 208, the generative content system 120 can receive subsequent user input 207 to request additional responsive content. If no subsequent user input 207 is received, then the generative content system 120 may wait for subsequent user input 207 to be received at block 208. However, if subsequent user input 207 is received, then the reprocessing engine 170 can determine to generate additional responsive content with or without determining an alternative subset of vision data, based on the subsequent user input 207. Continuing with the above example where the user input 201 is “what does that sign mean”, further assume that the user of the client device 110 provides subsequent user input of “not that sign, the sign on the right” (e.g., via a subsequent spoken utterance). In this example, the subsequent user input 207 indicates that the user of the client device 110 would like additional responsive content that is responsive to a different sign than the additional responsive content 206.

Accordingly, in this example, the reprocessing engine 170 can determine to generate additional responsive content by determining an alternative subset of the vision data of the user input 201 (e.g., by performing an additional understanding procedure based on the subsequent user input 207), and determining the additional responsive content based on the alternative subset of the vision data (e.g., by performing an additional response generation procedure based on the alternative subset of the vision data, and optionally the subsequent user input 207). Thus, in an additional understanding procedure, the GM input engine 141 can cause the explicitation GM to include the subsequent user input 207 (or a representation thereof) in processing of additional GM input(s) to generate an alternative subset of the vision data (e.g., to bias focus of the subset of vision data away from the original sign and/or towards the other sign) based on the subsequent user input 207. For instance, the additional GM input(s) can be generated to include the subsequent user input 207 verbatim (e.g., “Identify the most prominent sign present in the vision data, provide an indication of one or more frames in which this sign is clearly visible; in addition consider the following subsequent user input: not that sign, the sign on the right”), or an instruction generated based on the subsequent user input can be included in the GM input(s) (e.g., “Identify the most prominent sign present in the vision data and a prominent sign located on right of the scene captured by the vision data, ignore the most prominent sign and provide an indication of one or more frames in which the other sign is clearly visible”). In some implementations, the additional GM input(s) can be generated to include a representation of the initial responsive content. Further, in an additional response generation procedure, the additional responsive content can be generated based on the alternative subset of the vision data as described above (e.g., without use of the subsequent user input 207). Additionally or alternatively, in the additional response generation procedure, the GM input engine 141 can cause the explicitation GM to include the subsequent user input 207 (or a representation thereof) in processing of additional GM input(s) to generate additional responsive content (e.g., to bias the responsive content away from being responsive to the original sign and/or towards being responsive to the other sign) based on the subsequent user input 207. For instance, the additional GM input(s) can be generated to include the subsequent user input 207 verbatim (e.g., “Provide a meaning of the sign present in the vision data, translate any text present on the sign from Japanese to English; in addition, consider the following subsequent user input: not that sign, the sign on the right”), or an instruction generated based on the subsequent user input 207 can be included in the GM input(s) (e.g., “Provide a meaning of a sign located on the right of the scene captured in the vision data, translate any text present on the sign from Japanese to English”). In some implementations, the additional GM input(s) can be generated to include a representation of the initial responsive content.

Alternatively, in this example, the reprocessing engine 170 can determine to generate additional responsive content based on the subsequent user input 207 and without determining an alternative subset of the vision data of the user input 201 (e.g., by performing an additional response generation procedure based on the subsequent user input 207 and the original subset of the vision data). In an additional response generation procedure, the GM input engine 141 can cause the explicitation GM to include the subsequent user input 207 (or a representation thereof) in processing of additional GM input(s) to generate additional responsive content (e.g., to bias the responsive content away from being responsive to the original sign and/or towards being responsive to the other sign) based on the subsequent user input 207. For instance, the additional GM input(s) can be generated to include the subsequent user input 207 verbatim (e.g., “Provide a meaning of the sign present in the vision data, translate any text present on the sign from Japanese to English; in addition, consider the following subsequent user input: not that sign, the sign on the right”), or an instruction generated based on the subsequent user input 207 can be included in the GM input(s) (e.g., “Provide a meaning of a sign located on the right of the scene captured in the vision data, translate any text present on the sign from Japanese to English”). In some implementations, the additional GM input(s) can be generated to include a representation of the initial responsive content (e.g., the initial responsive content verbatim).

Continuing with this example, the rendering engine 112 can cause the additional responsive content to be rendered at the client device 110 of the user. The user can continue interacting with the generative content system 120 in this manner to continue generating additional responsive content.

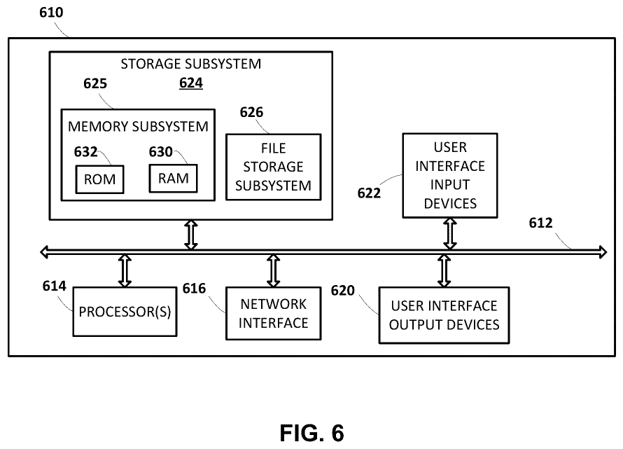

Turning now to FIG. 3A, a flowchart illustrating an example method 300A of using a generative model (GM) to generate content responsive to vision data is depicted. For convenience, the operations of the method 300A are described with reference to a system that performs the operations. This system of the method 300A includes one or more processors, memory, and/or other component(s) of computing device(s) (e.g., generative content system 120 of FIG. 1, computing device 610 of FIG. 6, one or more servers, and/or other computing devices). For instance, the example method 300A can be performed by a remote computing device. Moreover, while operations of the method 300A are shown in a particular order, this is not meant to be limiting. One or more operations may be reordered, omitted, and/or added.

At block 352, the system receives a stream of vision data, where the stream of vision data has been generated based on sensor data from one or more vision components of a client device. For instance, the stream of vision data can include a plurality of sequential image frames. In some implementations, the plurality of sequential image frames correspond to a time period in which the spoken utterance was spoken. For instance, the system and/or the client device may have already determined which image frames of an originally captured stream of vision data correspond to the time period in which the spoken utterance was spoken, and only these image frames are included in the received stream of vision data.

At block 354, the system receives a representation of a spoken utterance, where the received spoken utterance has been captured in audio data generated by one or more microphones of the client device. For instance, the representation of the spoken utterance can include the audio data capturing the spoken utterance, text data determined based on a transcription of the spoken utterance (e.g., determined at the client device, determined by the system based on received audio data capturing the spoken utterance, etc.), NLU data determined based on an NLU of a transcription of the spoken utterance and/or audio data capturing the spoken utterance (e.g., determined at the client device, determined by the system, etc.), etc.

At block 356, the system processes, using a GM, first GM input to generate corresponding first GM output. The first GM input includes at least the stream of vision data and the representation of the spoken utterance. For example, the system can generate the first GM input (e.g., as described with respect to the GM input processing engine 141 of FIGS. 1 and 2), and can process the first GM input, using the GM, to generate the first GM output (e.g., as described with respect to the GM processing engine 142 of FIGS. 1 and 2).

Although it has generally been described that a single GM is used to generate the first GM output, it will be appreciated that in some implementations, a plurality of GMs can be used. For instance, in some implementations, one GM can be used to process GM input including the stream of vision data and another GM can be used to process GM input including the representation of the spoken utterance respectively.

At block 358, the system determines, based on the first GM output, a subset of the stream of vision data. For example, the system can determine subset of the stream of vision data based on one or more probability distributions over one or more sequences of tokens (e.g., as described with respect to the GM output engine 143 of FIGS. 1 and 2).

In some implementations, the stream of vision data can include a plurality of sequential image frames. In some of these implementations, the subset of the stream of vision data includes a subset of the plurality of sequential image frames. Additionally, or alternatively, the subset of the stream of vision data can include one or more masked frames of the subset of sequential image frames, one or more cropped frames of the sequential image frames, one or more extracted objects from the sequential image frames, etc. In some implementations, the subset of the stream of vision data can include NL text describing the stream of vision data. In some implementations, the subset of the stream of vision data can include latent data usable by a GM to determine responsive content (e.g., because the GM has been fine-tuned to generate responsive content based on such latent data). In some implementations, the subset of the stream of vision data can be processed to remove sensitive or private information. For instance, instances of faces, text indicative of names, locations, financial information, etc. recognized in the stream of vision data can be removed or obscured in the subset of vision data (e.g., by masking, cropping, blurring, etc.). In some implementations, this can be performed locally, such that the sensitive or private information is not transmitted to external devices.

At block 360, the system processes, using the GM, second GM input to generate corresponding second GM output. The second GM input includes at least the subset of the stream of vision data and the representation of the spoken utterance. For example, the system can generate the second GM input (e.g., as described with respect to the GM input processing engine 141 of FIGS. 1 and 2), and can process the second GM input, using the GM, to generate the second GM output (e.g., as described with respect to the GM processing engine 142 of FIGS. 1 and 2).

Although, it has generally been described that the same GM (or GMs, as the case may be) are used to generate the first GM output and the second GM output, it will be appreciated that other arrangements can be used. For instance, in some implementations, a first GM (or GMs) can be used in block 356 to generate the first GM output, and a second GM can be used in block 360 to generate the second GM output. In some of those implementations, generating the first GM output using the first GM can be less computationally expensive than generating the second GM output using the second GM. For instance, the first GM can be a reduced version of the second GM (e.g., relative to the second GM, the first GM can have less weights, a lower token limit, etc.). In this way, a relatively inexpensive “understanding” procedure using the first GM can identify germane information present in the stream of vision data (i.e., by identifying a subset of the stream of vision data). The relatively more expensive “response generation” procedure using the second GM can then be conducted based on only the germane information present in the original stream of vision data. In other words, the amount of data processed in the relatively expensive response generation procedure can be reduced, conserving computational resources that would otherwise be consumed.

At block 362, the system determines, based on the second GM output, responsive content, wherein the responsive content is responsive to the spoken utterance and the stream of vision data. For example, the system can determine the responsive content based on one or more probability distributions over one or more sequences of tokens (e.g., as described with respect to the GM output engine 143 of FIGS. 1 and 2).

At block 364, the system causes the responsive content to be rendered at the client device (e.g., visually and/or audibly). For instance, the system can transmit data, to the client device, that is operable for causing the client device to render the responsive content. Responsive to receiving the data, the client device can render the responsive content.

Turning now to FIG. 3B, a flowchart illustrating an example method 300B of using a generative model (GM) to generate content responsive to vision data is depicted. For convenience, the operations of the method 300B are described with reference to a system that performs the operations. This system of the method 300B includes one or more processors, memory, and/or other component(s) of computing device(s) (e.g., client device 110 of FIG. 1, computing device 610 of FIG. 6, and/or other computing devices). For instance, the example method 300B can be performed by a client device. Moreover, while operations of the method 300B are shown in a particular order, this is not meant to be limiting. One or more operations may be reordered, omitted, and/or added.

At block 370, the system obtains sensor data captured by one or more sensors of a client device, wherein the sensor data includes at least a stream of vision data generated by one or more vision components of the client device, and audio data generated by one or more microphones of the client device.

At block 372, the system determines, based on the audio data, a representation of a spoken utterance captured in the audio data. For instance, the system can identify that the audio data includes a spoken utterance. The system can thus determine the portion of the audio data that captures the spoken utterance as the representation of the spoken utterance. In some implementations, the system can transcribe the spoken utterance, or can cause the spoken utterance to be transcribed by an external device (e.g., by sending the audio data capturing the spoken utterance to a remote computing device, and receiving information indicative of the transcription responsively). The system can thus determine the transcription as the representation of the spoken utterance. In some implementations, the system can determine a NLU representation of the spoken utterance (e.g., by performing NLU using a GM or a separate NLU model (e.g., stored in the ML model(s) database 180), or by sending the audio data capturing the spoken utterance and/or a transcription of the spoken utterance to a remote computing device, and receiving information indicative of the NLU representation of the spoken utterance responsively). The system can thus determine the NLU representation of the spoken utterance as the representation of the spoken utterance.

At block 374, the system determines a subset of the stream of vision data. In some implementations, the system can determine which frames of the stream of vision data correspond to a period of time in which the spoken utterance in the audio data was spoken. For instance, the system can determine a starting frame from the stream of vision data corresponding to a time when the spoken utterance was started. Additionally, or alternatively, the system can determine an ending frame from the stream of vision data corresponding to a time when the spoken utterance ended. The system can then exclude frames of the obtained stream of vision data which were captured prior to the starting frame and/or after the ending frame from being included in the subset of vision data. In some of these implementations, the system can determine this while the stream of vision data is obtained. For instance, the system can determine that the obtained audio data includes a spoken utterance before the spoken utterance has finished. The system can then determine a starting frame before the spoken utterance has finished. Once the system determines that the spoken utterance has finished, the ending frame can be determined.

In some implementations, the system can determine the subset of the stream of vision data based on an understanding procedure performed locally. For instance, block 374 can include operations substantially similar to those described in relation to block 356 and 358 of method 300A of FIG. 3A. In particular, in some implementations, the system can process, using a generative model (GM), first GM input to generate corresponding first GM output, the first GM input including at least the stream of vision data and the representation of the spoken utterance. For example, the system can generate the first GM input (e.g., as described with respect to the GM input processing engine 141 of FIGS. 1 and 2), and can process the first GM input, using the GM, to generate the first GM output (e.g., as described with respect to the GM processing engine 142 of FIGS. 1 and 2). The system can then determine, based on the first GM output, the subset of the stream of vision data. For example, the system can determine the responsive content based on one or more probability distributions over one or more sequences of tokens (e.g., as described with respect to the GM output engine 143 of FIGS. 1 and 2).

At block 376, the system sends, to a remote computing device, the subset of the stream of vision data and the representation of the spoken utterance. Responsive to receiving the subset of the stream of vision data and the representation of the spoken utterance, the remote computing device can perform one or more operations described in relation to method 300A of FIG. 3A.

At block 378, the system receives, from the remote computing device, responsive content, wherein the responsive content is responsive to the stream of vision data and the spoken utterance.

At block 380, the system renders, at the client device, the responsive content.

Turning now to FIG. 4, a flowchart illustrating an example method 400 of generating additional responsive content based on a subsequent user input. For convenience, the operations of the method 400 are described with reference to a system that performs the operations. This system of the method 400 includes one or more processors, memory, and/or other component(s) of computing device(s) (e.g., client device 110 of FIG. 1, generative content system 120 of FIG. 1, computing device 610 of FIG. 6, one or more servers, and/or other computing devices). Moreover, while operations of the method 400 are shown in a particular order, this is not meant to be limiting. One or more operations may be reordered, omitted, and/or added.

At block 450, the system causes responsive content to be rendered at the client device. For instance, block 450 may be similar to block 364 of FIG. 3A and/or block 380 of FIG. 3B.

At block 460, the system determines whether subsequent user input has been received. If at an iteration of block 460, the system determines that no subsequent user input has been received, then the system can continue monitoring for subsequent user input at block 460. In some implementations, the system can continue monitoring for subsequent user input for a threshold amount of time, a threshold number of iterations, a threshold number of processor cycles, and/or an indication from the user that the rendered responsive content is accepted is received, etc. If, at an iteration of block 460, the system determines that subsequent user input is received, the system proceeds to block 470. The subsequent user input can include, for instance, a subsequent spoken utterance, text entered by a user (e.g., via a virtual or physical keyboard), selection of a graphical element rendered at the client device, interaction with a physical control interface (e.g., pushing of a virtual or physical button)). The system can determine a representation of the subsequent user input based on the subsequent user input. For instance, the representation of the subsequent user input can include NL text generated based on the subsequent user input (e.g., a transcription of a spoken utterance, text entered by the user, a command associated with a selected graphical element, etc.).

At block 470, the system determines whether to determine an alternative subset of stream of vision data. If, at block 470, the system determines to determine an alternative subset of the stream of vision data, the system proceeds to block 472. At block 472, the system determines, based on the subsequent user input, an alternative subset of the stream of vision data. For instance, the system can process using a GM, third GM input to generate corresponding third GM output. The third GM input can include at least the stream of vision data, the representation of the spoken utterance, and the representation of the subsequent user input. For example, the system can generate the third GM input (e.g., as described with respect to the GM input processing engine 141 of FIGS. 1 and 2), and can process the third GM input, using the GM, to generate the third GM output (e.g., as described with respect to the GM processing engine 142 of FIGS. 1 and 2). The system can then determine, based on the third GM output, an alternative subset of the stream of vision data. For example, the system can determine the alternative subset of the stream of vision data based on one or more probability distributions over one or more sequences of tokens (e.g., as described with respect to the GM output engine 143 of FIGS. 1 and 2).

At block 474, the system determines, based on the alternative subset of the stream of vision data, additional responsive content. For instance, the system can process, using the GM, fourth GM input to generate corresponding fourth GM output. The fourth GM input can include at least the alternative subset of the stream of vision data, the representation of the spoken utterance. In some implementations, the fourth GM input can also include the representation of the subsequent user input. For example, the system can generate the fourth GM input (e.g., as described with respect to the GM input processing engine 141 of FIGS. 1 and 2), and can process the fourth GM input, using the GM, to generate the fourth GM output (e.g., as described with respect to the GM processing engine 142 of FIGS. 1 and 2). The system can then determine, based on the fourth GM output, the additional responsive content, wherein the additional responsive content is responsive to the spoken utterance, the stream of vision data and the subsequent user input. For example, the system can determine the additional responsive content based on one or more probability distributions over one or more sequences of tokens (e.g., as described with respect to the GM output engine 143 of FIGS. 1 and 2).

Additionally, or alternatively, the system can send, to a remote computing device, the alternative subset of the stream of vision data, the representation of the spoken utterance, and optionally the subsequent user input. Responsively, the system can receive the additional responsive content from the remote computing device.

If, at block 470, the system determines not to determine an alternative subset of the stream of vision data, the system proceeds to block 480. At block 480, the system determines whether to determine additional responsive content without determining an alternative subset of the stream of vision data. If, at block 480, the system determines not to determine additional responsive content without determining an alternative subset of the stream of vision data, the system returns to block 460, where the system can continue monitoring for subsequent user input. If, at block 480, the system determines to determine additional responsive content without determining an alternative subset of the vision data, the system proceeds to block 482.

At block 482, the system determines, based on the subsequent user input, additional responsive content. For instance, the system can process, using the GM, fifth GM input to generate corresponding fifth GM output. The fifth GM input can include at least the subset of the stream of vision data, the representation of the spoken utterance, and the representation of the subsequent user input. For example, the system can generate the fifth GM input (e.g., as described with respect to the GM input processing engine 141 of FIGS. 1 and 2), and can process the fifth GM input, using the GM, to generate the fifth GM output (e.g., as described with respect to the GM processing engine 142 of FIGS. 1 and 2). The system can then determine, based on the fifth GM output, the additional responsive content, wherein the additional responsive content is responsive to the spoken utterance, the stream of vision data and the subsequent user input. For example, the system can determine the additional responsive content based on one or more probability distributions over one or more sequences of tokens (e.g., as described with respect to the GM output engine 143 of FIGS. 1 and 2).

Additionally, or alternatively, the system can send, to a remote computing device, the subset of the stream of vision data, the representation of the spoken utterance, and the subsequent user input. Responsively, the system can receive the additional responsive content from the remote computing device.

Although method 400 is illustrated as including block 470 followed by block 480, in some implementations, these blocks can be combined, or only one of these blocks can be included. For instance, in some implementations, a determination can be made as to whether to determine additional responsive content at all. For instance, this can be determined based on contextual information (e.g., whether or not the user has been allocated resources of the system to generate additional responsive content), based on the subsequent user input (e.g., whether the subsequent user input is indicative of a request which is impossible or inappropriate, etc.), or any other information. In some implementations, a determination can be made as to whether to determine an alternative subset of the stream of vision data when determining the additional responsive content. This can, for instance, again be based on contextual information (e.g., whether the user has been allocated resources of the system to generate an alternative subset of vision data), the subsequent user input (e.g., the extent to which the subsequent user input indicates that the rendered responsive content does not satisfy the requested vision-based task), or any other information. However, in some implementations, no determination is made, and the system can always determine additional responsive content with determining an alternative subset of the vision data or the system can always determine additional responsive content without determining an alternative subset of the vision data.

At block 490, the system causes additional responsive content to be rendered at the client device. For instance, the system can transmit data to the client device that is operable for causing the client device to render the additional responsive content. Alternatively, the system can receive the additional responsive content, and render, at the client device, the responsive content. The system then returns to block 460, where the system monitors for further subsequent user input, and method 400 can repeat.

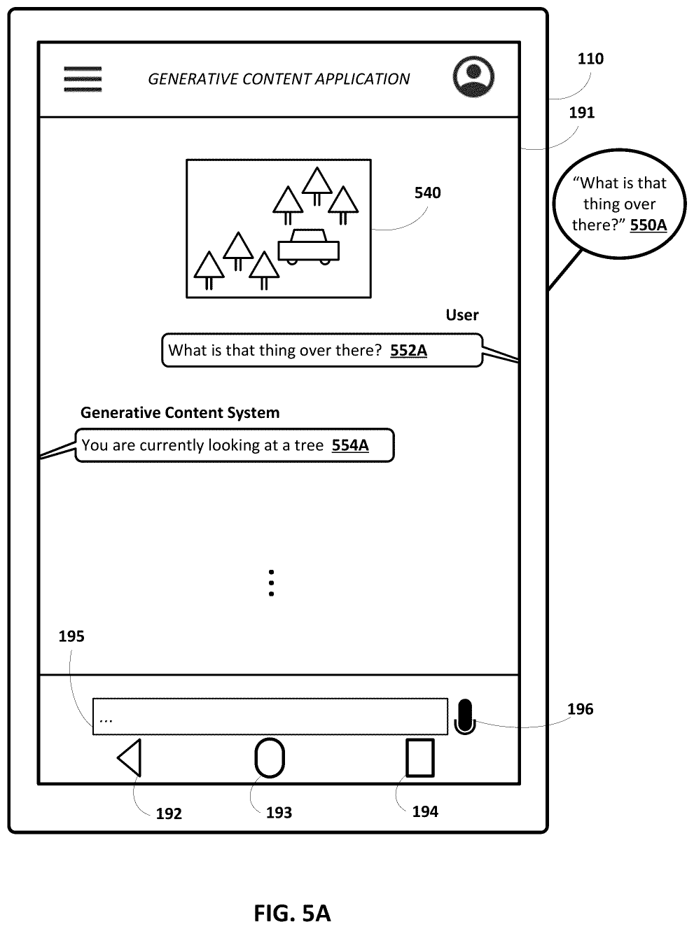

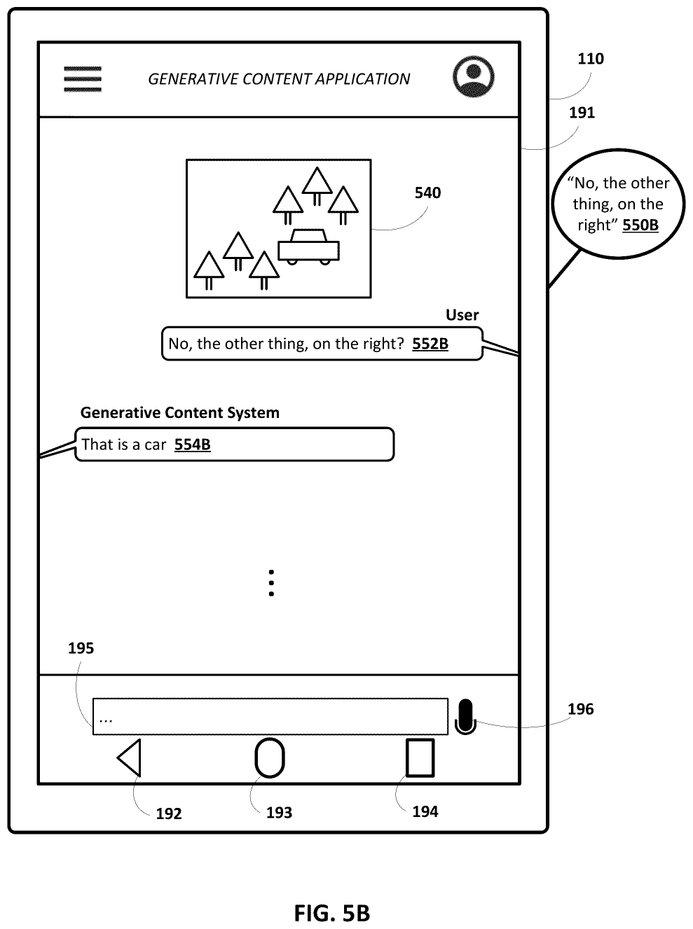

Turning now to FIGS. 5A, and 5B, various non-limiting examples of generating content responsive to vision data are depicted. A client device 110 (e.g., the client device 110 from FIG. 1) may include various user interface components including, for example, microphone(s) to generate audio data based on spoken utterances and/or other audible input, speaker(s) to audibly render synthesized speech and/or other audible output, and/or a display 191 to visually render visual output. Further, the display 191 of the client device 110 can include various system interface elements 192, 193, and 194 (e.g., hardware and/or software interface elements) that may be interacted with by a user of the client device 110 to cause the client device 110 to perform one or more actions. The display 191 of the client device 110 enables the user to interact with content rendered on the display 191 by touch input (e.g., by directing user input to the display 191 or portions thereof (e.g., to a text entry box 195, to a keyboard (not depicted), or to other portions of the display 191)) and/or by spoken input (e.g., by selecting microphone interface element 196—or just by speaking without necessarily selecting the microphone interface element 196 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIGS. 5A, and 5B is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 5A, assume that a user of the client device 110 accesses a generative content application, via the client device 110, that enables the user to interact with a generative content system (e.g., the generative content system 120 of FIG. 1). Further assume that the user provides user input 552A of “What is that thing over there?” by providing a corresponding spoken utterance 550A. Further assume that the user provides user input 540 of vision data captured by one or more vision components of the client device 110. The vision data can capture an environment of the client device 540, which in this case includes a car surrounded by trees. In response to receiving the user inputs 552A and 540, the generative content system can generate responsive content (e.g., as described with respect to FIG. 3A or FIG. 3B). For example, based on the user input 552A “What is that thing over there?” and the corresponding vision data 540 capturing an environment including a car surrounded by trees, the generative content system can generate responsive content 554A of “You are currently looking at a tree”.

Referring now specifically to FIG. 5B, assume that, at a later time, the user provides the subsequent user input 552B of “No, the other thing, on the right” by providing a corresponding spoken utterance 550B. In response to receiving the user inputs 552A, 540, and 552B, the generative content system can generate additional responsive content 554B (e.g., as described with respect to FIG. 4). For example, based on the user input 552A “What is that thing over there?”, the corresponding vision data 540 capturing an environment including a car surrounded by trees, and the subsequent user input 552B “No, the other thing, on the right?”, the generative content system can generate additional responsive content 554B of “That is a car”.

Turning now to FIG. 6, a block diagram of an example computing device 610 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving a stream of vision data, the stream of vision data being generated based on sensor data from one or more vision components of a client device; receiving a representation of a spoken utterance, the spoken utterance being captured in audio data generated by one or more microphones of the client device; processing, using a generative model (GM), first GM input to generate corresponding first GM output, the first GM input comprising at least the stream of vision data and the representation of the spoken utterance; determining, based on the first GM output, a subset of the stream of vision data; processing, using the GM, second GM input to generate corresponding second GM output, the second GM input comprising at least the subset of the stream of vision data and the representation of the spoken utterance; and determining, based on the second GM output, responsive content. The responsive content is responsive to the spoken utterance and the stream of vision data. The method further includes causing the responsive content to be rendered at the client device.

These and other implementations of technology disclosed herein can optionally include one or more of the following features.

In some implementations, the stream of vision data may include a plurality of sequential image frames. In some versions of those implementations, the plurality of sequential image frames may correspond to a time period in which the spoken utterance was spoken. In some additional or alternative versions of those implementations, the subset of the stream of vision data may include a subset of the plurality of sequential image frames.

In some additional or alternative implementations, the stream of vision data may capture an environment of the client device. The responsive content may be responsive to an object in the environment captured by the stream of vision data. In some versions of those implementations, the stream of vision data may include one or more frames capturing a hand of a user pointing toward the object. In additional or alternative versions of those implementations, the spoken utterance may identify the object based on one or more properties of the object. In some further versions of those implementations, the properties of the object may include a location of the object in the environment captured in the stream of vision data. In some additional or alternative further versions of those implementations, the properties of the object may include a color of the object. In some additional or alternative versions of those implementations, the spoken utterance may include a request to identify the object, from among a plurality of objects present in the environment, based on a prominence of the object in the stream of vision data. In some versions of those implementations, the prominence of the object may be determined based on one or more of: a size of the object in the stream of vision data, a number and/or percentage of frames of the stream of vision data capturing the object, and a determined distance between the client device and the object.

In some additional or alternative implementations, causing the responsive content to be rendered at the client device may include transmitting data to the client device that is operable for causing the client device to render the responsive content.

In some additional or alternative implementations, the method may further include: receiving subsequent user input; responsive to determining, based on the subsequent user input, to determine an alternative subset of the stream of vision data; processing, using the GM, third GM input to generate corresponding third GM output, the third GM input including at least the subset of the stream of vision data, the representation of the spoken utterance, and a representation of the subsequent user input; determining, based on the third GM output, the alternative subset of the stream of vision data; processing, using the GM, fourth GM input to generate corresponding fourth GM output, the fourth GM input including at least the alternative subset of the stream of vision data, the representation of the spoken utterance, and optionally the representation of the subsequent user input; and determining, based on the fourth GM output, additional responsive content. The additional responsive content may be responsive to the spoken utterance, the stream of vision data and the subsequent user input. The method may further include causing the client device to render the additional responsive content.

In some additional or alternative implementations, the method may further include: receiving subsequent user input; responsive to determining, based on the subsequent user input, to determine additional responsive content without determining an alternative subset of the stream of vision data, processing, using the GM, fifth GM input to generate corresponding fifth GM output, the fifth GM input including at least the subset of the stream of vision data, the representation of the spoken utterance, and a representation of the subsequent user input; and determining, based on the fifth GM output, additional responsive content. The additional responsive content may be responsive to the spoken utterance, the stream of vision data, and the subsequent user input. The method may further include causing the client device to render the additional responsive content.

In some versions of those implementations, the responsive content may be responsive to an object from among a plurality of objects captured by the stream of vision data, and the subsequent user input may be indicative of a request for additional responsive content responsive to another of the plurality of objects captured by the stream of vision data. In some additional or alternative versions of those implementations, the representation of the subsequent user input may be indicative of a request to generate additional responsive content which is not responsive to the object. In some additional or alternative versions of those implementations, causing the additional responsive content to be rendered at the client device may include transmitting data to the client device that is operable for causing the client device to render the additional responsive content.

In some implementations, a method implemented by one or more processors is provided, and includes: obtaining sensor data captured by one or more sensors of a client device. The sensor data includes at least a stream of vision data generated by one or more vision components of the client device, and audio data generated by one or more microphones of the client device. The method further includes determining, based on the audio data, a representation of a spoken utterance captured in the audio data; determining a subset of the stream of vision data; sending, to a remote computing device, the subset of the stream of vision data and the representation of the spoken utterance; and receiving, from the remote computing device, responsive content. The responsive content is responsive to the stream of vision data and the spoken utterance. The method further includes rendering, at the client device, the responsive content.

These and other implementations of technology disclosed herein can optionally include one or more of the following features.

In some implementations, determining the subset of the stream of vision data may include: determining, based on the audio data, which frames of the stream of vision data correspond to a period of time in which the spoken utterance was spoken. In some versions of those implementations, determining, based on the audio data, which frames of the stream of vision data correspond to a period of time in which the spoken utterance was spoken may include: determining a starting frame from among the stream of vision data corresponding to a time when the spoken utterance was started; and excluding frames of the stream of vision data which were captured prior to the starting frame from being included in the subset of the stream of vision data. In some additional or alternative versions of those implementations, determining, based on the audio data, which frames of the stream of vision data correspond to a period of time in which the spoken utterance was spoken may include: determining an ending frame from among the stream of vision data corresponding to a time when the spoken utterance ended; and excluding frames of the stream of vision data captured after the ending frame from being included in the subset of the stream of vision data.

In some additional or alternative implementations, the subset of the stream of vision data may be determined while the stream of vision data is obtained.

In some additional or alternative implementations, determining the subset of the stream of vision data may include: processing, using a GM, first GM input to generate corresponding first GM output, the first GM input including at least the stream of vision data and the representation of the spoken utterance; and determining, based on the first GM output, the subset of the stream of vision data.

In some additional or alternative implementations, the stream of vision data may capture an environment of the client device. The responsive content may be responsive to an object in the environment captured by the stream of vision data. In some versions of those implementations, the stream of vision data may include one or more frames capturing a hand of a user pointing toward the object. In additional or alternative versions of those implementations, the spoken utterance may identify the object based on one or more properties of the object. In some further versions of those implementations, the properties of the object may include a location of the object in the environment captured in the stream of vision data. In some additional or alternative further versions of those implementations, the properties of the object may include a color of the object. In some additional or alternative versions of those implementations, the spoken utterance may include a request to identify the object, from among a plurality of objects present in the environment, based on a prominence of the object in the stream of vision data. In some versions of those implementations, the prominence of the object may be determined based on one or more of: a size of the object in the stream of vision data, a number and/or percentage of frames of the stream of vision data capturing the object, and a determined distance between the client device and the object.

In some additional or alternative implementations, the method may further include: receiving subsequent user input; responsive to determining, based on the subsequent user input, to determine an alternative subset of the stream of vision data; processing, using the GM, second GM input to generate corresponding second GM output, the second GM input including at least the subset of the stream of vision data, the representation of the spoken utterance, and a representation of the subsequent user input; determining, based on the second GM output, the alternative subset of the stream of vision data; sending, to the remote computing device, the alternative subset of the stream of vision data the representation of the spoken utterance, and optionally the representation of the subsequent user input; and receiving, from the remote computing device, additional responsive content. The additional responsive content may be responsive to the stream of vision data, the spoken utterance and the subsequent user input. The method may further include rendering, at the client device, the additional responsive content.

In some additional or alternative implementations, the method may further include: receiving subsequent user input; responsive to determining, based on the subsequent user input, to determine additional responsive content without determining an alternative subset of the stream of vision data, sending, to the remote computing device, the representation of the subsequent user input; and receiving, from the remote computing device, additional responsive content. The additional responsive content may be responsive to the stream of vision data, the spoken utterance and the subsequent user input. The method may further include rendering, at the client device, the additional responsive content.

In some versions of those implementations, the responsive content may be responsive to an object from among a plurality of objects captured by the stream of vision data, and the subsequent user input is indicative of a request for additional responsive content responsive to another of the plurality of objects captured by the stream of vision data. In some additional or alternative versions of those implementations, the representation of the subsequent user input may be indicative of a request to generate additional responsive content which is not responsive to the object.

In some implementations, a method implemented by one or more processors is provided, and includes: receiving a stream of vision data, the stream of vision data being generated based on sensor data from one or more vision components of a client device; receiving a representation of a spoken utterance, the spoken utterance being captured in audio data generated by one or more microphones of the client device; processing, using a first GM, first GM input to generate corresponding first GM output, the first GM input comprising at least the stream of vision data and the representation of the spoken utterance; determining, based on the first GM output, a subset of the stream of vision data; processing, using a second GM, second GM input to generate corresponding second GM output, the second GM input comprising at least the subset of the stream of vision data and the representation of the spoken utterance. The first GM is a reduced version of the second GM; determining, based on the second GM output, responsive content, and the responsive content is responsive to the spoken utterance and the stream of vision data. The method further includes causing the responsive content to be rendered at the client device.

In some implementations, a method implemented by one or more processors is provided, and includes: obtaining sensor data captured by one or more sensors of a client device. The sensor data includes at least a stream of vision data generated by one or more vision components, and audio data generated by one or more microphones. The method further includes determining, based on the audio data, a representation of a spoken utterance captured in the audio data; processing, using a first GM, GM input to generate corresponding GM output, the GM input comprising at least the stream of vision data and the representation of the spoken utterance; determining, based on the GM output, a subset of the stream of vision data; sending, to a remote computing device, the subset of the stream of vision data and the representation of the spoken utterance; and receiving, from the remote computing device, responsive content. The responsive content is responsive to the stream of vision data and the spoken utterance and is generated using a second GM. The first GM is a reduced version of the second GM. The method further includes rendering, at the client device, the responsive content.

In some implementations, a method implemented by one or more processors of a computing system including a client device and a remote computing device is provided, and includes: obtaining, by the client device, sensor data captured by one or more sensors of the client device. The sensor data includes at least a stream of vision data generated by one or more vision components, and audio data generated by one or more microphones. The method further includes determining, by the client device, and based on the audio data, a representation of a spoken utterance captured in the audio data; determining, by the client device, a subset of the stream of vision data; sending, by the client device and to the remote computing device, the subset of the stream of vision data and the representation of the spoken utterance; processing, by the remote computing system and using a GM, GM input to generate corresponding GM output, the GM input comprising at least the subset of the stream of vision data and the representation of the spoken utterance; and determining, based on the GM output, responsive content. The responsive content is responsive to the spoken utterance and the stream of vision data. The method further includes: sending, by the remote computing device and to the client device, the responsive content; and rendering, at the client device, the responsive content.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving a stream of vision data, the stream of vision data being generated based on sensor data from one or more vision components of a client device;
receiving a representation of a spoken utterance, the spoken utterance being captured in audio data generated by one or more microphones of the client device;
processing, using a generative model (GM), first GM input to generate corresponding first GM output, the first GM input comprising at least the stream of vision data and the representation of the spoken utterance;
determining, based on the first GM output, a subset of the stream of vision data;
processing, using the GM, second GM input to generate corresponding second GM output, the second GM input comprising at least the subset of the stream of vision data and the representation of the spoken utterance;
determining, based on the second GM output, responsive content, wherein the responsive content is responsive to the spoken utterance and the stream of vision data; and
causing the client device to render the responsive content.

2. The method of claim 1, wherein the stream of vision data comprises a plurality of sequential image frames.

3. The method of claim 2, wherein the plurality of sequential image frames corresponds to a time period in which the spoken utterance was spoken.

4. The method of claim 2, wherein the subset of the stream of vision data comprises a subset of the plurality of sequential image frames.

5. The method of claim 1, wherein the stream of vision data captures an environment of the client device, wherein the responsive content is responsive to an object in the environment captured by the stream of vision data.

6. The method of claim 5, wherein the stream of vision data includes one or more frames capturing a hand of a user pointing toward the object.

7. The method of claim 5, wherein the spoken utterance identifies the object based on one or more properties of the object.

8. The method of claim 7, wherein the properties of the object comprise a location of the object in the environment captured in the stream of vision data.

9. The method of claim 7, wherein the properties of the object comprise a color of the object.

10. The method of claim 5, wherein the spoken utterance includes a request to identify the object, from among a plurality of objects present in the environment, based on a prominence of the object in the stream of vision data.

11. The method of claim 10, wherein the prominence of the object is determined based on one or more of: a size of the object in the stream of vision data, a number and/or percentage of frames of the stream of vision data capturing the object, and a determined distance between the client device and the object.

12. The method of claim 1, further comprising:
receiving subsequent user input;
responsive to determining, based on the subsequent user input, to determine an alternative subset of the stream of vision data;
processing, using the GM, third GM input to generate corresponding third GM output, the third GM input comprising at least the subset of the stream of vision data, the representation of the spoken utterance, and a representation of the subsequent user input;
determining, based on the third GM output, the alternative subset of the stream of vision data;
processing, using the GM, fourth GM input to generate corresponding fourth GM output, the fourth GM input comprising at least the alternative subset of the stream of vision data, the representation of the spoken utterance, and optionally the representation of the subsequent user input;
determining, based on the fourth GM output, additional responsive content, wherein the additional responsive content is responsive to the spoken utterance, the stream of vision data and the subsequent user input; and
causing the client device to render the additional responsive content.

13. The method of claim 1, further comprising:
receiving subsequent user input;
responsive to determining, based on the subsequent user input, to determine additional responsive content without determining an alternative subset of the stream of vision data, processing, using the GM, fifth GM input to generate corresponding fifth GM output, the fifth GM input comprising at least the subset of the stream of vision data, the representation of the spoken utterance, and a representation of the subsequent user input;
determining, based on the fifth GM output, additional responsive content, wherein the additional responsive content is responsive to the spoken utterance, the stream of vision data, and the subsequent user input; and
causing the client device to render the additional responsive content.

14. The method of claim 13, wherein the responsive content is responsive to an object from among a plurality of objects captured by the stream of vision data, and wherein the subsequent user input is indicative of a request for additional responsive content responsive to another of the plurality of objects captured by the stream of vision data.

15. The method of claim 14, wherein the representation of the subsequent user input is indicative of a request to generate additional responsive content which is not responsive to the object.

16. A method implemented by one or more processors, the method comprising:
obtaining sensor data captured by one or more sensors of a client device, wherein the sensor data comprises at least a stream of vision data generated by one or more vision components of the client device, and audio data generated by one or more microphones of the client device;
determining, based on the audio data, a representation of a spoken utterance captured in the audio data;
determining a subset of the stream of vision data;
sending, to a remote computing device, the subset of the stream of vision data and the representation of the spoken utterance; and
receiving, from the remote computing device, responsive content, wherein the responsive content is responsive to the stream of vision data and the spoken utterance; and
rendering, at the client device, the responsive content.

17. The method of claim 16, wherein determining the subset of the stream of vision data comprises:
determining, based on the audio data, which frames of the stream of vision data correspond to a period of time in which the spoken utterance was spoken.

18. The method of claim 17, wherein determining, based on the audio data, which frames of the stream of vision data correspond to a period of time in which the spoken utterance was spoken comprises:
determining a starting frame from among the stream of vision data corresponding to a time when the spoken utterance was started; and
excluding frames of the stream of vision data which were captured prior to the starting frame from being included in the subset of the stream of vision data.

19. The method of claim 17, wherein determining, based on the audio data, which frames of the stream of vision data correspond to a period of time in which the spoken utterance was spoken comprises:
determining an ending frame from among the stream of vision data corresponding to a time when the spoken utterance ended; and
excluding frames of the stream of vision data captured after the ending frame from being included in the subset of the stream of vision data.

20. A system comprising:
at least one processor; and
memory storing instructions that, when executed by the at least one processor, cause the at least one processor to be operable to:
receive a stream of vision data, the stream of vision data being generated based on sensor data from one or more vision components of a client device;
receive a representation of a spoken utterance, the spoken utterance being captured in audio data generated by one or more microphones of the client device;
process, using a generative model (GM), first GM input to generate corresponding first GM output, the first GM input comprising at least the stream of vision data and the representation of the spoken utterance;
determine, based on the first GM output, a subset of the stream of vision data;
process, using the GM, second GM input to generate corresponding second GM output, the second GM input comprising at least the subset of the stream of vision data and the representation of the spoken utterance;
determine, based on the second GM output, responsive content, wherein the responsive content is responsive to the spoken utterance and the stream of vision data; and
cause the client device to render the responsive content.
